(19) United States
(12) Patent Application Publication
(10) Pub. No.: US 2022/0287246 A1
(43) Pub. Date: Sep. 15, 2022

(54) PRECISION LIGHT DIRECTED PHOTOTROPISM

(71) Applicant: Samuel WESTLIND, Bozeman, MT (US)

(72) Inventor: Samuel WESTLIND, Bozeman, MT (US)

(21) Appl. No.: 17/608,404

(22) PCT Filed: May 11, 2020
(86) PCT No.: PCT/US2020/032337

§ 371 Date: Nov. 2, 2021

Related U.S. Application Data
(60) Provisional application No. 62/977,870, filed on Feb. 18, 2020.
(60) Provisional application No. 62/845,440, filed on May 9, 2019.

(51) Int. Cl. A01G 7/04; F21V 11/00

(52) U.S. Cl. CPC A01G 7/045; F21V 11/00; F21Y 2115/10

(57) ABSTRACT

A controlled phototropic growth environment configured to encourage directional control of plant growth of one or more planted crops, thereby enabling a more efficient use of space within the growth environment. The growth environment including an enclosure comprising a plurality of panels configured to at least partially surround one or more planted crops therewithin, an array of light sources operably coupled to at least one panel of the plurality of panels, the array of light sources configured to emit a source of light to provide directional control of plant growth of the one or more planted crops, and an array of apertures defined within at least one panel of the plurality of panels, the array of apertures configured to emit a source of conditioned gas to circulate air within the enclosure.

This application claims the benefit of U.S. Provisional Application No. 62/845,440 (filed May 9, 2019) and 62/977,870 (filed Feb. 18, 2020), the contents of which are fully incorporated herein by reference.

### TECHNICAL FIELD

The present disclosure relates generally to a high growth, high density, high throughput, closed environment hydroponic system, and more particularly to a light bank for an indoor horticultural system having improved photon directional control and environmental conditioning capabilities.

### BACKGROUND

The cost of growing and providing vegetables and other planted crops to the population is increasing. As populated areas and urban centers grow, less land is available for conventional farming. As a result, conventional farming is being moved further away from population centers. The increased distance required to transport the produce grown on conventional farms contributes to an increase in consumer costs. The produce is also not as fresh as it once was, as the produce must now travel a further distance.

In an effort to address these concerns, over the years, various hydroponic systems for indoor growth have been developed. One such hydroponic system is disclosed in Patent Cooperation Treaty App Ser. No. PCT/US2018/062035, the contents of which are hereby incorporated by reference herein. Although such systems provide improvements in the use of space and resources in the growth of planted crops, further improvements are desired.

In particular, conventional indoor growth systems typically use a single, fixed light source as a replacement for natural sunlight as the planted crops grow from seedlings to mature plants. The area surrounding the planted crop is generally an unenclosed space, open to the macro environment, thereby enabling a sufficient space for workers to service the planted crops. Accordingly, as the planted crops grow, they typically do so in an upwardly direction, towards the single fixed light source (commonly referred to as “positive phototropism”). Although various systems and methods, such as the use of screens and nets, have been employed as an aid in spreading the plant canopy for a more efficient use of space within the grow environment, such practices are generally considered labor-intensive.

Additionally, although light sources of conventional indoor growth systems generally offer the intensities and uniformity necessary for indoor crop production, they are known to generate a substantial and undesirable amount of heat. In high indoor production growth systems, the single, fixed light source may include light bulbs, each of which generates unwanted heat. To prevent the planted crops from overheating, the heat generated by the light bulbs must be removed from the grow environment.

Controlled environment agriculture buildings housing indoor growth systems typically utilize expensive and generally inefficient HVAC systems to condition the entire macro environment within the facility. Such indoor growth systems may often utilize local fans to generate air movement around the plant the crops. Where local fans are used, the planted crops closest to the fans are typically overexposed to moving air, while the planted crops furthest from the fans receive little to no air movement. Without proper circulation, temperature differentials within the grow environment can form, which can result in stagnant air and possible crop disease and or pathogen outbreaks and/or pest harborage.

The present disclosure addresses these concerns.

### SUMMARY OF THE DISCLOSURE

Embodiments of the present disclosure provide a light bank for indoor horticultural systems having improved photon directional control and environmental conditioning capabilities. In one embodiment, the light bank can be configured to emit a source of light to provide directional control of plant growth of planted crops. In one embodiment, the light bank can further include an array of apertures configured to emit a source of conditioned gas to provide uniform air delivery, optimized gas recipes, light heat removal, a control of at least one of the temperature and humidity, and/or the introduction of nutrients to the local air volume canopy environment and leaf boundary layer of planted crops. In one embodiment, the light bank can include a plurality of panels configured to form an enclosure at least partially surrounding one or more planted crops. In one embodiment, the enclosure can be a six-sided enclosure, wherein each of the sides includes an array of LEDs.

One embodiment of the present disclosure provides a controlled phototropic growth environment configured to encourage directional control of plant growth of one or more planted crops, thereby enabling a more efficient use of space within the growth environment. The growth environment can include an enclosure, and array of light sources, and an array of apertures. The enclosure can include a plurality of panels configured to at least partially surround one or more planted crops therewithin. The array of light sources can be operably coupled to at least one panel of the plurality of panels, and can be configured to emit a source of light to provide directional control of plant growth of the one or more planted crops. The array of apertures can be defined within at least one panel of the plurality of panels, and can be configured to emit a source of conditioned gas to circulate air within the enclosure.

In one embodiment, the controlled phototropic growth environment can further include at least one fin operably coupled to at least one panel of the plurality of panels, the at least one fin configured to provide at least one of a light differential and/or directional control of conditioned gas emitted from the array of apertures. In one embodiment, the at least one fin can include a second array of light sources. In one embodiment, the at least one fin can include a second array of apertures configured to emit the conditioned gas. In one embodiment, the growth environment can include at least one vertically oriented fin and at least one horizontally oriented fin.

In one embodiment, the growth environment can further include a carrier frame including a vertical plant growth media for growth of the one or more planted crops. In one embodiment, the carrier frame can be configured to move relative to the enclosure. In one embodiment, the enclosure can include a track along which the carrier frame traverses. In one embodiment, at least one panel of the plurality of panels can be removable from the enclosure.

Another embodiment of the present disclosure provides a light bank configured to encourage directional control of plant growth of planted crops. The light bank can include a panel, and array of LEDs, and an array of apertures. The panel can have a primary surface, a rear surface, and a core position therebetween. The array of LEDs can be operably coupled to the primary surface of the panel and can be configured to emit a source of light to provide directional control of plant growth of planted crops. The array of apertures can be defined within the primary surface of the panel and can be configured to emit a source of conditioned gas.

In one embodiment, at least one fin can be operably coupled to the panel, the at least one fin configured to provide at least one of a light differential and/or directional control of conditioned gas emitted from the array of apertures. In one embodiment, the at least one fin can include a second array of LEDs. In one embodiment, the at least one fin can include a second array of apertures configured to emit the conditioned gas. In one embodiment, an angle of the at least one fin with respect to the primary surface can be adjustable. In one embodiment, the panel can include at least one vertically oriented fin and at least one horizontally oriented fin.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting a light bank including a panel having an array of LEDs, wherein a plurality of fins extend from a surface of the panel, in accordance with an embodiment of the disclosure.

FIG. 2 is a perspective view depicting a light bank including a panel having an array of LEDs, wherein a plurality of fins also including LEDs extend from a surface of the panel, in accordance with an embodiment of the disclosure.

FIG. 3 is a perspective view depicting a light bank including a panel having a plurality of fins extending therefrom at a distance proportional to a growth stage of the planted crops, in accordance with an embodiment of the disclosure.

FIG. 4 is a perspective view depicting a light bank including a panel having an array of LEDs and a plurality of fins extending from a surface of the panel, wherein the panel and fins define a plurality of apertures configured to enable a flow of environmentally conditioning gas therethrough, in accordance with an embodiment of the disclosure.

FIG. 5 is a schematic view depicting one or more light banks and/or enclosures for use in the growth of an agricultural crop, in accordance with an embodiment of the disclosure.

FIG. 6 is a partial, cross-sectional, perspective view depicting an enclosure formed from a plurality of light bank panels forming a four-sided enclosure, wherein each of the sides includes an array of LEDs, in accordance with an embodiment of the disclosure.

FIG. 7 is a partial, cross-sectional, perspective view depicting an enclosure formed from a plurality of light bank panels configured to at least partially surround one or more planted crops, in accordance with an embodiment of the disclosure.

FIG. 8 is a perspective view depicting a controlled phototropic indoor horticulture grow environment, in accordance with a first embodiment of the disclosure.

FIG. 9 is a perspective view depicting a controlled phototropic indoor horticulture grow environment, in accordance with a second embodiment of the disclosure.

FIG. 10 is a perspective view depicting a controlled phototropic indoor horticulture grow environment, in accordance with a third embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

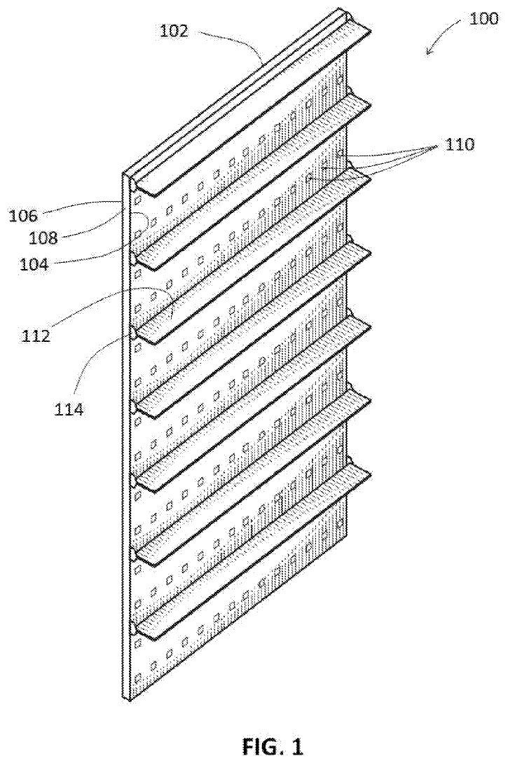

Referring to FIG. 1, a light bank 100 for indoor horticultural system having improved photon directional control and environment conditioning capabilities is depicted in accordance with an embodiment of the disclosure. In one embodiment, the light bank 100 can include a panel 102 having a primary surface 104, a rear surface 106 and a core 108 positioned therebetween. In one embodiment, the panel 102 can be constructed of a thin flexible, semi-rigid, or rigid sheet. An array of LEDs 110 can be coupled to the panel 102 such that light from the array of LEDs 110 is generally emitted from the primary surface 104. In one embodiment, electrical wiring (not depicted) coupling the array of LEDs to a power source can be embedded within the core 108 of the panel 102.

As further depicted in FIG. 1, in one embodiment, the light bank 100 can include one or more fins 112 extending outwardly from the primary surface of the panel 102. In one embodiment, the one or more fins 112 can extend generally orthogonally from the primary surface 104 of the panel. In other embodiments, the extension angle of the one or more fins outwardly from the primary surface 104 of the panel 102 can be adjustable, for example via hinge 114. In one embodiment, the one or more fins are configured to provide directional control of the light emitted by the LEDs 110, thereby improving directional growth control during various growth stages of the planted crops. For example, in one embodiment, the fins 112 can be utilized to establish a shadow or light differential, which can aid in encouraging plant growth in a particular direction.

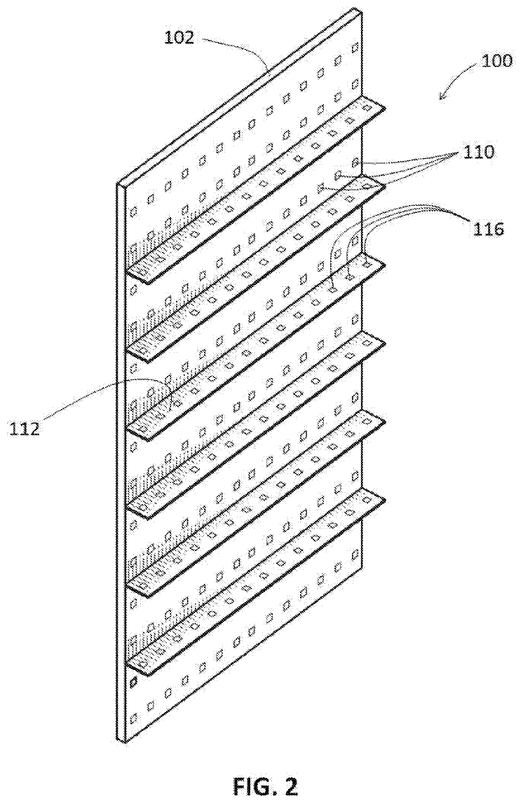

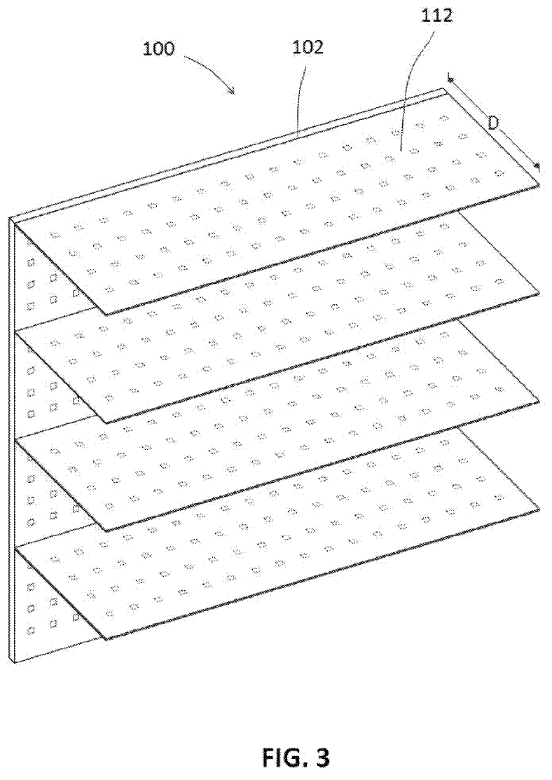

Referring to FIG. 2, in some embodiments, an array of LEDs 116 can be positioned on the one or more fins 112. In such embodiments, the LEDs 116 can be on one or both sides of the fins 112. As depicted in FIG. 3, in some embodiments, the depth (D) of the one or more fins 112 can be proportional to a growth stage of the planted crops. For example, in one embodiment, the one or more fins 112 can have a depth (D) of between about 1 inch and about 80 inches; although other depths are also contemplated.

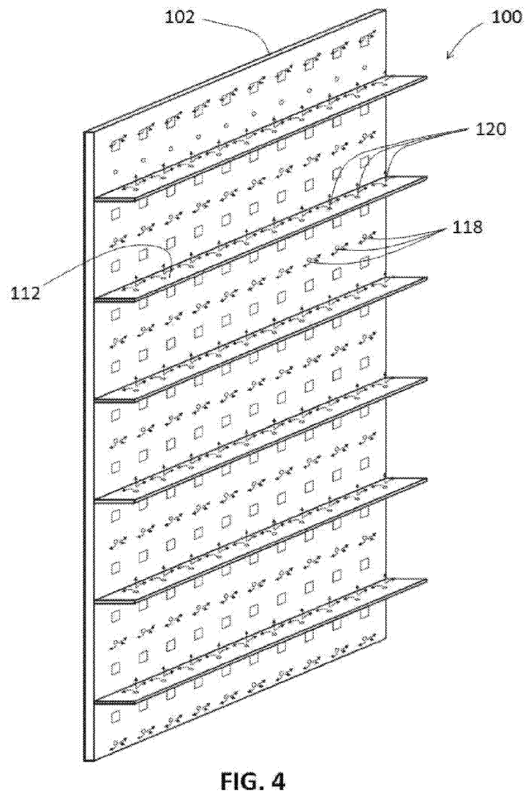

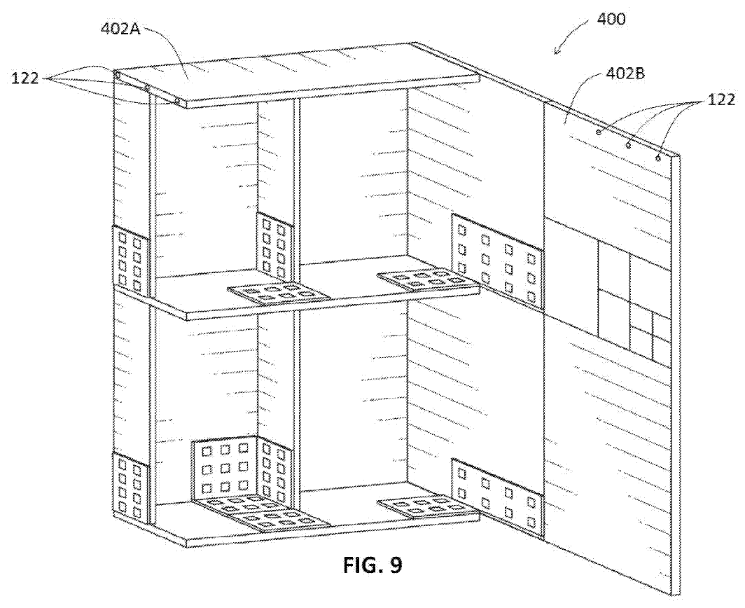

Referring to FIG. 4, in one embodiment, at least the primary surface 104 of the panel 102 can define a plurality of apertures 118 configured to enable a flow of environmental conditioning gas therethrough. In some embodiments, the one or more fins 112 can additionally include a plurality of apertures 120 for an improve flow of environmental conditioning gas. In some embodiments, the core 108 of the panels 102 can define one or more channels 122 (as depicted in FIG. 9) through which the environmental conditioning gas can flow. In some embodiments, the environmental conditioning gas can provide uniform air delivery, optimized gas recipes, light heat removal, a control of at least one of the temperature, humidity, and/or introduction of nutrients to the local air volume canopy environment and leaf boundary layer of planted crops. In some embodiments, the one or more fins 112 can be configured to direct the flow of environmental conditioning gas in relation to the planted crops.

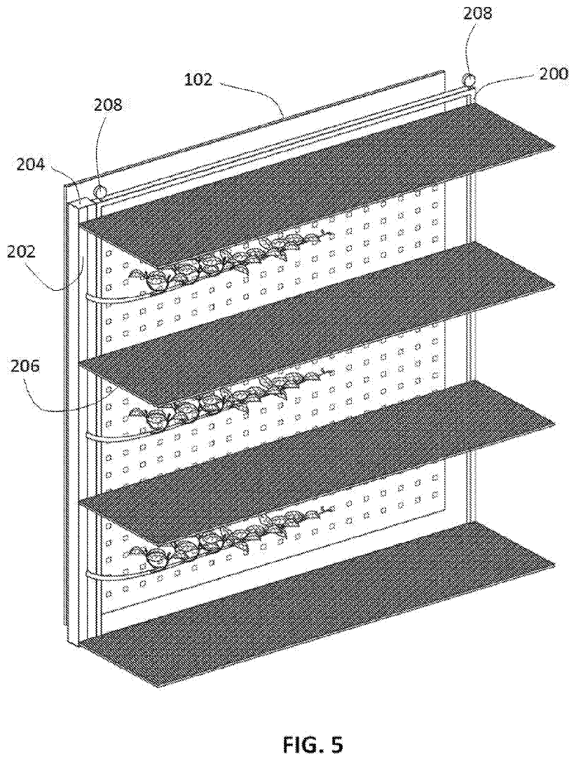

With additional reference to FIG. 5, use of a light bank 100 in conjunction with a carrier frame 200 is depicted in accordance with an embodiment of the disclosure. In one embodiment, the carrier frame 200 can include plant growth media 202, including a root zone environment 204 configured to nourish and support roots of the planted crops. In some embodiments, plant growth media 202 can be a vertically oriented field, such that the root zone environment 204 as a height of about 6 feet, with a corresponding depth and width of about 6 inches; although other dimensions of the plant growth media 202 are also contemplated. In some embodiments, the carrier frame can further include one or more plant restraints 206 configured to provide directional growth control of the planted crops.

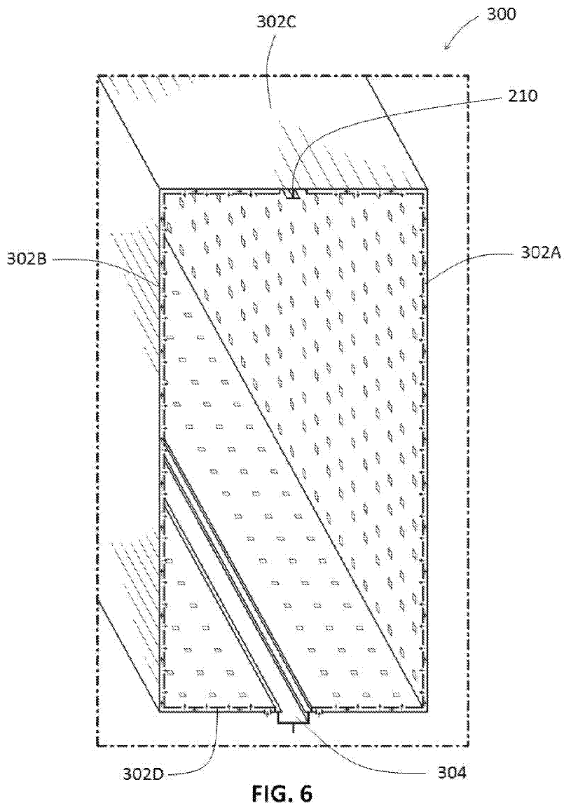

In some embodiments, the light bank 100 can be stationary, while the carrier frame 200 can be configured to move relative to the light bank 100, for example via a one or more wheels 208 positioned on a track 210 (as depicted in FIGS. 6, 8 and 10). In such embodiments, multiple light banks 100 can be utilized to establish a light recipe across a natural growth cycle of the planted crops, in some cases representing an ideal light spectrum across a growth season from seedling to harvest. For example, in one embodiment, a first light bank can be configured to provide optimal growth conditions (e.g., sunlight, temperature, humidity, etc.) for germination and growth of seedlings, a second light bank can provide optimal growth conditions for quickly adding mass to the plant, and a third light bank can provide optimal growth conditions to maximize harvest. In other embodiments, the light banks 100 can emit light for desired phototropic directional growth control and/or other environmental conditions to simulate an ideal spring, summer, and fall as the planted crops move relative to a light bank 100. Other light bank quantities and configurations are also contemplated.

Accordingly, in some embodiments, as the planted crops mature, the carrier frame 200 advances relative to the light bank 100 until the planted crops have reached their maturity, which in some embodiments can be approximately 6 feet in length. During this time, the light bank 100 including its array of LEDs 110/116 can provide a sufficient quantity of light to enable growth of the planted crops in a desired direction (e.g., horizontally), and/or with desirable canopy characteristics. In some embodiments, one or more fins 112 included on the light bank 100 can further aid in directional/canopy control by establishing light differentials to encourage plant growth in a particular direction. One or more apertures 118/120 of the light bank can direct a flow of environmental conditioning gas to aid in heat removal, and optionally to control at least one of a temperature and/or humidity of the air surrounding the plants. In some embodiments, the one or more apertures 118/120 can further be configured to introduce an optimized gas recipe including one or more nutrients into the growth environment.

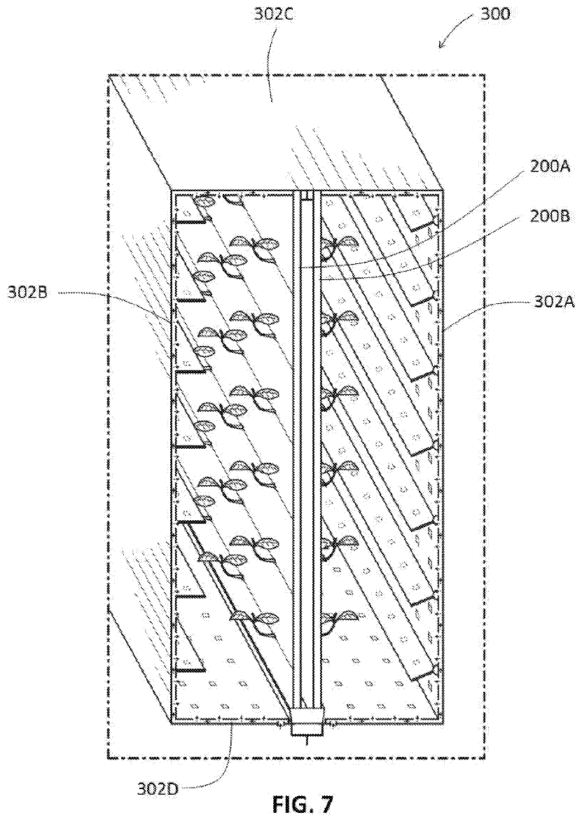

Referring to FIGS. 6 and 7, in one embodiment, a plurality of panels 102A-D can be configured to form an enclosure 300 to at least partially surround a vertical field having planted crops of one or more carrier frames 200A-B. For example, in one embodiment, the enclosure 300 can be a four-sided controlled phototropic growth environment 300 through which a carrier frame 200 can traverse, wherein each of the sides 302A-D of the growth environment 300 includes an array of LEDs 110, 116, configured to deliver a light intensity sufficient to enable directed phototropism of planted crops, thereby serving as an aid in maximizing the limited space within the growth environment 300 with growth of the planted crop. In some embodiments, one or more fins 112, and apertures 118/120 can further aid in directional growth control of the planted crops within the growth environment. In one embodiment, a trough or channel 304 can be positioned beneath the carrier frame 200 to catch falling debris, water, nutrients, and planted crop matter.

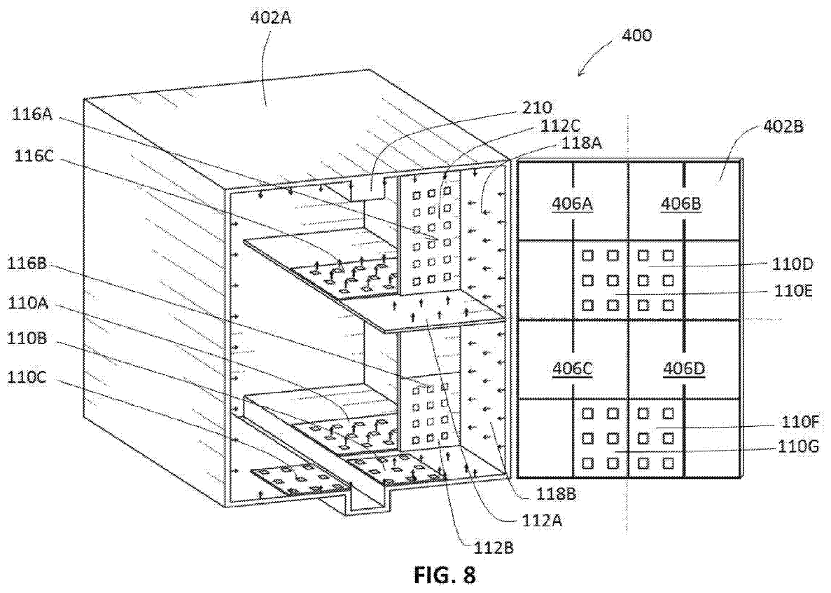

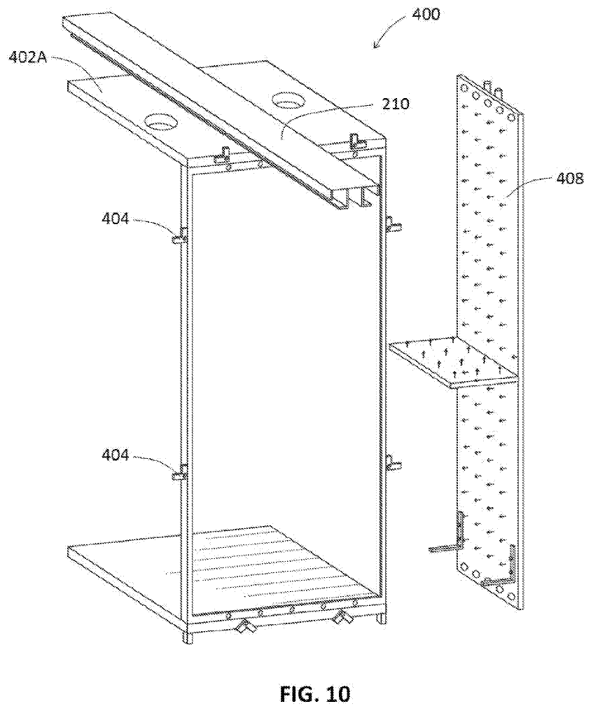

Referring to FIG. 8-9, a six-sided controlled phototropic growth environment 400 is depicted in accordance with an embodiment of the disclosure. In some embodiments, the controlled phototropic growth environment 400 can include a first structure 402A (e.g., representing a rear, left, right, top and bottom panels) and a second structure 402B (e.g., representing a removable front panel), configured to enable static or continuous production of crops with horizontal or vertical hydroponic or aeroponic systems. In some embodiments, the second structure 402B can be removably coupled to the first structure 402A via one or more latches 404 (as depicted in FIG. 10).

In one embodiment, the first and second structures 402A/B can be comprised of various panels 102 (like that described in connection with FIGS. 1-4), which can include LEDs 110A-G/116A-C, fins 112A-C, apertures 118A-B, and other features as described herein for directional growth control over the course of various plant stages. In some embodiments, the lighting systems 110A-G/116A-C can be individually controllable, and can be positioned on any and/or all sides of the grow environment 400, including a removable front panel 402B. In some embodiments, the lighting systems 110A-G/116A-C can be fixed or adjustable to maintain ideal Photosynthetic Photon Flux Density (PPFD) and spacing to promote phototropic plant growth within the grow environment 400.

For example, in one embodiment, one or more side panels of the first structure 402A can include fins 112A-C (including horizontal fin 112A and vertical fins 112B-C), which can each include at least one lighting system 116A-C. In one embodiment, a bottom panel of the first structure 402A can include one or more lighting systems 110A-C. In one embodiment, the front panel 102B can include a lighting system 110D-G in each of four distinct quadrants 406A-D within the grow environment 400. Other lighting configurations are also contemplated. With reference to FIG. 10, in some embodiments, one or more distinct panels 408 of the first structure 402A can be selectively detached for improved access to areas within the enclosure area of the grow environment 400.

In some embodiments, the grow environment 400 can remain stationary, while a vertical field containing the planted crops is advanced through the grow environment 400, for example along a rail system 210. In some embodiments, one or more lighting systems 110/116 within the grow environment 400 can be configured to move relative to other portions of the grow environment 400, for example during the first stages of growth as an aid in maintaining ideal PPFD and spacing. For example, in one embodiment, an end bank of lights can retract as the plant grows horizontally to maintain ideal PPFD and spacing. In one embodiment, a side bank of lights can retract as the plant canopy grows to maintain ideal PPFD and spacing. Accordingly, embodiments of the present disclosure enable controlled directional plant growth, as well as optimal light intensity across crop canopy surfaces with optimal waste heat removal and proper environmental control for an ideal grow season at a granular, per plant leaf basis thus offering superior crop health, higher yields and a faster cycle time to harvest. Such systems enable gains in efficiency for scaling hydroponic indoor commercial farm production, thereby enabling crops to be profitably grown indoors.

In some embodiments, the grow environment 400 can be configured as an array of units (e.g., a row of 14 units), having a single input front door 402B, a single output back door, and one or more side access doors 408 per unit, thereby enabling improved access to the enclosed grow environment 400. In some embodiments, each of the doors can include one or more fins 112 having one or more light arrays 116 attached as needed during each representative plant growth stage. In some embodiments, one or more of the doors can be slidably coupled to a rail system 210, thereby enabling the door to be top suspended and slide outwardly away from the grow environment 400 to enable unit servicing with little to no obstructions, including cable management.

Embodiments of the present disclosure provide a controlled phototropic grow environment. Such a system can be configured to enable static or continuous production of crops with horizontal or vertical hydroponic systems. The controlled phototropic grow environment system can form a grow environment. The grow environment can have one or more banks of lighting systems configured for the one or more sides of a grow environment for directional growth control of various plant stages. The banks of lights can be used individually. The grow environment ends can be a bank of lights. A grow environment bank of lights can be fixed or adjustable to maintain ideal Photosynthetic Photon Flux Density (PPFD) and ideal spacing for light directed phototropism. The bank of light systems can be thin film light panels serving as both the light source and the grow environment. The controlled phototropic grow environment system can include fins. The controlled phototropic grow environment bank of lights and fins can be hollow with surface apertures for precision, uniform air delivery, light heat removal, precise individual plant site delivery of gases, temperature, humidity or dehumidification, nutrients and other plant needs. The fins can include a bank of lights. The fins can be of any orientation. The fins can be of different widths and length. The grow environment can include a field. The field can be vertical or horizontal. The vertical field can have a bank of lights behind it within the modified Root Zone Environment™, between the rails and gutter. The horizontal field can have a bank of lights under it. The field surface can be a bank of lights. The controlled phototropic grow environment system can remain stationary. The field can be configured to advance as the crop grows. A light bank can be configured to move. For example, during the first several grow stations. An end bank of lights can retract as the plant grows horizontally to maintain ideal PPFD and spacing. For example, the side bank of lights can retract as the plant canopy grows to maintain ideal PPFD and spacing. Such a farm system offers the controlled directional plant growth needed and the light intensity necessary across all crop canopy surfaces with optimal waste heat removal and proper environmental control for an ideal grow season at a granular, per plant leaf basis thus offering superior crop health, higher yields and a faster cycle time to harvest. Such systems enable gains in efficiency for scaling hydroponic indoor commercial farm production, thereby enabling new crops to be profitably grown indoors.

In one embodiment, a vertical field can have one or more large canopy plants. In one embodiment, the vertical field can be mounted in a carrier frame configured for the desired phototropic canopy horizontal length, depth and height. The carrier frame can have narrow field and the remaining carrier frame is open. In one embodiment, the carrier frame can have plant restraints and or plant supports depending on crop requirements to maintain proper PPFD and boundary layer airflow. In another embodiment, the vertical field can be surrounded by an enclosure with one or more sides. In one embodiment, the one or more sides can consist of light banks. In one embodiment, the back of the vertical field can be in front of a vertical light bank. As the vertical field in the carrier frame advances, the light bank within the modified Root Zone Environment™, between the rails and gutter, behind the vertical field in the carrier frame is exposed. In one embodiment, the vertical field surface is a light bank. In one embodiment, a vertical light bank can be an outer portion of the enclosure. In one embodiment, additional light banks can be on the top, ends and bottom of the enclosure. In one embodiment, fins can be perpendicular to the light bank face. In one embodiment, the fins can project several feet perpendicular from the light bank face. In one embodiment, during the growth stage, the vertical light banks on the bottom, behind the vertical field, the vertical field surface light bank and the outer vertical light bank can be used to make a plant grow horizontally out and down towards each bank of lights, thus allowing the plant canopy to uniformly fill out the entire volumetric space. In one embodiment, a plant restraint above the growing plant can limit vertical growth. In one embodiment, once the plant achieves the desired dimensions of length and girth to maximize canopy uniform branch density within the growth enclosure during the horizontal growth stage, the vertical field can advance to allow the flowering stage. In one embodiment, flower supports can replace the plant restraints. In one embodiment, all light banks can be utilized to generate massive colas and flowers. In one embodiment, the outer perimeter of the enclosure can be of panels to create a sealed, controlled growth environment.

For less robust crops such as greens and grains, in one embodiment, fins can be used to create a light differential on a bank of lights face. In one embodiment, a surface of a fin can be lighted. In one embodiment, the fins can be spaced according to crop requirements. In one embodiment, the fins can be of different lengths. In one embodiment, as the vertical fields advance as the crop grows, the fins can be of greater length. Seedlings need to grow up and out. A modern light bank is sufficiently bright and tuned to create zero light disparity. To achieve labor savings, eliminate plant transfers and to create faster crop cycles vertical field, in situ, propagation of crops is necessary. However, such a light bank can make a seedling grow out before the stem is strong enough to grow up, possibly causing a “J” hook in a plant stem. In an effort to eliminate inefficient growth, a fin can be utilized that creates a light differential, thereby encouraging the plant to naturally grow up, while creating enough of a light differential or shade that the plant seeks the next highest light thus allowing a plant, such as greens and wheat, to naturally grow with enough stem strength to grow up and out in an efficient, timely manner.

This step can be utilized during seedling stage and the first several weeks within the farm. As the field advances the fins can terminate. Cereal crops such as wheat, the controlled phototropic grow environment system can be used on each field aperture. Horizontal field apertures can be utilized, and the light banks can have fixed or adjustable angle fins on the sides of each aperture. In one embodiment, the fin surfaces can be a light bank. This creates a multi sided light channel for each aperture in which all possible grow surfaces are exposed to lights. In such a manner, a crop can be directionally exposed to photons, as necessary, throughout the crop cycle. The fins also act as channels for precision air flow for each crop row. A traditional large fan at an end of the grow environment can be utilized to create grow environment air flow. The fins channel the air on a per row basis thus offering greater fluidic control to reduce dead air spaces or underserved plant sites. The controlled phototropic grow environment light banks and fins can be hollow or adhered to a channel system such as a soft and flexible Q-Sox fabric duct, a Polyimide, a rigid 16 mm Gallena storm panel, any commonly available poly materials or metal air ducting for precise fluidic control for temperature, humidity, nutrient, and optimal selected gas delivery on a per plant site basis. As the vertical field advances, the fins can be of increasing depth. For example, a seedling stage fin would protrude from the light surface approximately 1″. As the crop grows and advances through the continuous farm system, the fin depth can proportionately increase to greater than 1″.

With such a precision air delivery system, a fan and motor heat and noise source can be removed entirely from the grow environment. Air conditioning, heat, humidity and other gases can be remotely added to the airflow for an ideal grow season. A remote fan or fans can distribute air to single or multiple banks of lights. The air flow can be heated or cooled as needed to keep the grow environment optimal. The spacing for an air aperture can be as little as 1 mm up to inches or feet depending on the crop grown. Such precision air movement allows a very granular per plant site and even per plant leaf air boundary layer management of the grow environment. This eliminates a plant canopy surface from sticking to another plant surface or any surface within the grow environment and can ensure per leaf optimal growth. Such granular air control greatly reduces any still air or dead spots within the grow environment thus reducing disease or fungus potential and greatly reducing pest harborage. Such a precision air movement system incorporated with the bank of lights and fins allows two bulky formerly separate systems to become one, thus managing waste light heat and reducing the form factor to increase volumetric space efficiency. The air source can be filtered to clean room standards, filtered outside air and or recirculated depending on farm needs. Air waste can be vented directly out to the indoor farm facility environment or piped to exhaust outside. Increasing system efficiency and utilizing volumetric space efficiently while providing granular per plant site environmental control reduces the grow environment to the efficiencies of assembly line processes.

The vertical field and modular farm system demonstrated with the controlled phototropic grow environment system is patent pending Patent Cooperation Treaty App Ser. No. PCT/US2018/062035 and commercially available from AutoCrop LLC. The AutoCrop LLC modular farm reduces plant production to the efficiencies of assembly line processes. The EZ Rail™ and Root Zone Environment™ offers one binary input output low cost, common irrigation and drain that is a unobstructed root zone environment throughout the length and height of system run allowing the placement of additional tools. This binary vertical farm design allows a vertical field and precision light directed phototropism system to vertically scale efficiently while maintaining affordable proper climate control along the entire local canopy environment. Such as system used together offers a user the complete phototropic with complete environmental control of the local canopy environment and the complete control of the root zone environment. The AutoCrop LLC indoor farm vertical field modular system has been modified for vertical farm marijuana production. The controlled phototropic grow environment system can use light banks by GrowFilm™ by Heilux LLC on one or more grow environment surfaces to allow the marijuana plant leaves to be sufficiently exposed to light at all growth points. The AutoCrop Vertical Farm EZRail™ has been modified to place a bank of GrowFilm™ between the vertical fields. The vertical field surface has been modified with a flexible light film available from Growfilm™. The remote air delivery is via a Q-Sox fabric duct. As the vertical field advances, different light banks and light intensities are utilized to control directional growth to maximize plant canopy density within the grow enclosure. The Environmental control uses different wind speeds, air temperatures, gas composition and humidity to replicate an ideal grow season for the crop grown.

The seed, seedlings or clones are inserted into the vertical field apertures at the angle and pitch desired. As the plant grows out and up from the vertical field surface, the plant will eventually come into contact with a plant restraint above it. The plant is forced to grow towards the desired light banks on the sides, ends, and or top and bottom. As the vertical field advances over the next weeks, this creates a broad uniform canopy and uniform canopy density throughout the growth enclosure. When the plant reaches a desired size the field advances to the flowering stage. The plant restraints end and the flower supports begin. The top bank of lights and or other light banks are now utilized to encourage the uniform plant canopy colas flowers to grow both vertically, horizontally and any degree in between. Once the flowering stage is complete, the vertical field can be removed from the system for further processing. Such a continuous production and light system can also be utilized with traditional horizontal plane growing methods.

Embodiments of the present disclosure can include a mapped system ported airflow and placement of light assemblies per crop stage for efficient use of resources as the crop moves through the system from seed to harvest. In some embodiments, the grow environment can be organized into distinct quadrants to form the mapped space. These mapped quadrants enable an easy value system allow ease of manufacturing of panels and the placement of light arrays for a specific crop growth stage. Such a mapped space enables ease of operation and automation of a precision light directed phototropism environment. In embodiments representing a high-volume continuous production line, multiple vertical grow units can be placed together to form a linear array of production line units. Lighting systems can be attached to the enclosure by quadrant, specifically for each stage of crop growth and desired phototropic directional growth. Further, in some embodiments, lighting systems (e.g., light arrays) can be sized, tuned and spaced to each stage of crop growth, thus ensuring ideal PPFD and/or minimization of waste. Accordingly, embodiments of the present disclosure efficiently utilize volumetric space, while reducing agriculture the efficiencies to that of assembly line processes. Channels unnecessary for airflow can be utilized for hardware mounting, perforations for cable management etc. without risk of pressurized air losses.

Over the course of a typical growth cycle, cloned plants (herein referred to as “clones”) can be advanced through the grow environment 100 to ensure ideal PPFD. For example, during week 1, clones can be placed into a field. Thereafter, fields can be introduced into the grow environment 100 via an input door, which can be closed thereby fully enclosing the clones within the growth environment. A light bank, for example measuring 12 inches (H)×22 inches (W) can be positioned on the lower half of each quadrant on the front door input. Such a light bank can include a ported airflow by air channel within a corresponding panel. In such a manner, a clone can grow horizontally toward the lighted door instead of vertically. The ported airflow ensures that the plant site receives conditioned air and removal of waste heat from the immediate area.

In some embodiments, a second set of light banks measuring approximately 12 inches (H)×22 inches (W) can be on the bottom front quadrant of each plants grow space quadrant. With a set of lights on the door for directional horizontal growth and a set of light on the bottom, the clone will grow both horizontally towards the door quadrant, out and at a somewhat downward direction toward the lights on the bottom quadrant of the enclosure.

As the plant advances to week 2, additional lights can be placed according to the direction of growth the producer chooses. A vertical fin can protrude approximately 18-inches into the grow and have an approximately 22 inches (H)×12 inches (W) light bank attached. A vertical fin can have airflow ported to its air channel apertures. In this manner, the position of the clone can still be in close proximity to the door lights, while having access to the proper PPFD of the vertical fin member. Similar to week 1, a light bank can be on the bottom quadrant to continue the plant horizontal and downward growth. Additionally, a third light bank can be included on the side wall lower quadrant to allow the plant to grow out towards the wall of the enclosure. Variations of this precision directed phototropism can be employed throughout the rest of the grow to maximize directional growth to occupy the entire bottom half volume of the microenvironment enclosure.

When it is time to switch the clone to flower production, all necessary production line quadrants such as the top, sides, output end and bottom quadrants can have light banks, which can be utilized as necessary. Six-sided lighting can maximize clone colas, with the goal of filling the entire volume of the enclosed microenvironment. Accordingly, such a system and plant varietals generally can forgo leaf trimming, the use of nets, screens and the associated labor of such systems as the grow is completely controlled via precision light directed phototropism with granular per leaf photon and fluid delivery thus combining multiple formerly separate element and labor steps into to a multifunctional tool that enables high volume continuous production lines.

Multiple light banks defined within any given quadrant can be configured to replicate the sun from any direction. Cycled correctly these light banks offer even distribution of plant mass growth throughout the defined grow space enclosure. Controlling the direction of crop growth by independent quadrant light recipes to properly fill volumetric space represents significant efficiency gains versus traditional methods. Further, using multiple quadrant light banks and ported airflow in this manner to drive precision light directed phototropism with granular, per leaf fluid and photon delivery eliminates multiple steps of labor such as leaf trimming, netting, and low stress training thus helping remove the ingress, egress risk associated with human labor and associated pests or pathogens.

A light bank quadrant can be used to make a plant grow horizontally out and down towards each quadrant of lights, thus allowing the plant canopy to uniformly fill out the entire volumetric space. In one embodiment, all light bank quadrants can be utilized to generate massive colas and flowers. In one embodiment, the outer perimeter of the enclosure can be of panels to create a sealed, controlled growth environment. The controlled phototropic grow environment enclosure panels and fins can have independent air channels within a rigid 16 mm polycarbonate panel, any commonly available poly materials or metal air ducting for precise fluidic control for temperature, humidity, nutrient, and optimal selected gas delivery on a per plant site basis. As the vertical field advances, the fins can be of increasing depth. For example, a seedling stage fin would protrude from the light surface approximately 1″. As the crop grows and advances through the continuous farm system, the fin depth can proportionately increase to greater than 1″.

Ported airflow orifices can be configured to enable a small fan to pressurize multiple apertures within a given air channel. Thus, one small fan can service a large area with a series of active channels that correspond to light array quadrant placement and plant sites. For example, at the seedling stage unit, a smaller fan can be utilized. As the vertical field advances through the production line to the later stage units of crop maturity and more quadrants with light array are utilized, a larger fan can be used as more quadrant air channels are needed.

Each orifice port pressurizes a corresponding air channel aperture within a panel. Thus, one port can feed a channel within a fin, while another port can feed an entire vertical channel. One or several channels may be utilized for a small quadrant light array. Multiple channels can be used for a larger quadrant light array. Further, another port may feed several air channels for a light array quadrant of the front door and so forth.

A gasket between the AirFrame™ door and the unit frame seals around the port channels when the door is in the closed position, thus allowing proper airflow. With a small primary 315 CFM 35-watt 6-inch digital HYPERFAN® available from PHRESH LLC, we can pressurize an entire system enclosure from the top fin mounted fan and distribute air throughout a 16 MM polycarbonate 96 inches tall×48 inches wide AirFrame™ panel with three, 22-inch fins. With approximately 190 apertures serviced by approximately 15 orifice ported air channels, we can maintain 1.1 M/Sec to 1.6 M/Sec airflow across the entire AirFrame™ apertures. We use a single, 6-inch HYPERFAN® per side. If desired, an external HVAC system can be sized according to high-volume continuous production line specifications.

Air conditioning, heat, humidity and other gases can be remotely added to the airflow for an ideal grow season. A remote fan or fans can distribute air to single or multiple banks of lights. The air flow can be heated or cooled as needed to keep the grow environment optimal. The spacing for an air aperture can be as little as 1 mm up to inches or feet depending on the crop grown. Such precision air movement allows a very granular per plant site and even per plant leaf air boundary layer management of the grow environment. This eliminates a plant canopy surface from sticking to another plant surface or any surface within the grow environment and can ensure per leaf optimal growth. Such granular air control greatly reduces any still air or dead spots within the grow environment thus reducing disease or fungus potential and greatly reducing pest harborage. Such a precision air movement system incorporated with the bank of lights and fins allows two bulky formerly separate systems to become one, thus managing waste light heat and reducing the form factor to increase volumetric space efficiency. In some embodiments, the air source can be filtered to clean room standards, filtered outside air and or recirculated depending on farm needs. Air waste can be vented directly out to the indoor farm facility environment or piped to exhaust outside. Increasing system efficiency and utilizing volumetric space efficiently while providing granular per plant site environmental control reduces the grow environment to the efficiencies of assembly line processes.

In some embodiments, systems of the present disclosure can utilize 16 MM triwall polycarbonate panels to form the AirFrame™ enclosures, fins and doors. The lighting systems can be light arrays, such as the SPYDR and or RAZR series by Fluence Bioengineering, Inc. and/or Patriot Plus GrowFilms by Heilux, LLC, and can be configured to enable plant leaf exposure at all growth points per growth stage from seed to harvest. In some embodiments, the enclosures can utilize a pair of digital 6-inch HyperFans to power the AirFrames™. A remote air delivery can be via a Q-Sox fabric duct. As the vertical field advances, different light bank quadrants and light intensities can be utilized to control directional growth to maximize plant canopy density within the grow enclosure. The environmental control can use different wind speeds, air temperatures, gas composition and humidity to replicate an ideal grow season for the crop grown.

Accordingly, seeds, seedlings or clones can be inserted into the vertical field apertures at the angle and pitch desired. As the plant grows out and up from the vertical field surface, the plant can grow towards the desired light bank quadrants on the sides, ends and bottom. As the vertical field advances over the next weeks, a broad uniform canopy and uniform canopy density can be created throughout the lower quadrants of the growth enclosure. When the plant reaches a desired size the field advances to the flowering stage. During this stage, the upper quadrant bank of light and or overhead quadrant light banks can be utilized to encourage the uniform plant canopy colas to grow both vertically, horizontally and any degree in between. Once the flowering stage is complete, the vertical field can be removed from the system for further processing. Such an enclosed continuous production and light system can also be utilized with traditional horizontal plane growing methods. Such an enclosed continuous production system without light arrays can be used for high volume continuous production fungiculture.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A controlled phototropic growth environment configured to encourage directional control of plant growth of one or more planted crops, thereby enabling a more efficient use of space within the controlled phototropic growth environment, the controlled phototropic growth environment comprising:
an enclosure comprising a plurality of panels configured to at least partially surround one or more planted crops therewithin;
an array of light sources operably coupled to at least one panel of the plurality of panels, the array of light sources configured to emit a source of light to provide directional control of plant growth of the one or more planted crops; and
an array of apertures defined within at least one panel of the plurality of panels, the array of apertures configured to emit a source of conditioned gas to circulate air within the enclosure.

2. The controlled phototropic growth environment of claim 1, further comprising at least one fin operably coupled to at least one panel of the plurality of panels, the at least one fin configured to provide at least one of a light differential and/or directional control of conditioned gas emitted from the array of apertures.

3. The controlled phototropic growth environment of claim 2, wherein the at least one fin includes a second array of light sources.

4. The controlled phototropic growth environment of claim 2, wherein the at least one fin includes a second array of apertures configured to emit the conditioned gas.

5. The controlled phototropic growth environment of claim 2, wherein the enclosure includes at least one vertically oriented fin and at least one horizontally oriented fin.

6. The controlled phototropic growth environment of claim 1, further comprising a carrier frame including a vertical plant growth media for growth of the one or more planted crops.

7. The controlled phototropic growth environment of claim 6, wherein the carrier frame is configured to move relative to the enclosure.

8. The controlled phototropic growth environment of claim 7, wherein the enclosure includes a track along which the carrier frame traverses.

9. The controlled phototropic growth environment of claim 1, wherein at least one panel of the plurality of panels is removable from the enclosure.

10. A light bank configured to encourage directional control of plant growth of planted crops, the light bank comprising:
a panel having a primary surface, a rear surface, and a core position therebetween;
an array of LEDs operably coupled to the primary surface of the panel, the array of LEDs configured to emit a source of light to provide directional control of plant growth of planted crops; and
array of apertures defined within the primary surface of the panel, the array of apertures configured to emit a source of conditioned gas.

11. The light bank of claim 10, further comprising at least one fin operably coupled to the panel, the at least one fin configured to provide at least one of a light differential and/or directional control of conditioned gas emitted from the array of apertures.

12. The light bank of claim 11, wherein the at least one fin includes a second array of LEDs.

13. The light bank of claim 11, wherein the at least one fin includes a second array of apertures configured to emit the conditioned gas.

14. The light bank of claim 11, wherein an angle of the at least one fin with respect to the primary surface is adjustable.

15. The light bank of claim 11, wherein the panel includes at least one vertically oriented fin and at least one horizontally oriented fin.
